(19) United States
(12) Patent Application Publication
(10) Pub. No.: US 2009/0314624 A1
(43) Pub. Date: Dec. 24, 2009

(54) ENERGY EFFICIENT DISTILLATION SYSTEM AND METHOD

(76) Inventor: WALTER F. ALBERS, Paradise Valley, AZ (US)

Correspondence Address: MICHAEL WINFIELD GOLTRY, 4000 N. CENTRAL AVENUE, SUITE 1220, PHOENIX, AZ, 85012, US

(21) Appl. No.: 12/144,896

(22) Filed: Jun. 24, 2008

(51) Int. Cl. B01D 3/26

(52) U.S. Cl. 203/25; 202/158; 202/159

(57) ABSTRACT

A new distillation process of simultaneous evaporation and condensation distillation that enables efficient transfer of heat energy and allows binary fluids to attain different concentrations and temperatures in the stripper and rectifier stages is disclosed. The process utilizes preferential evaporation of the more volatile component in the stripper while in the rectifier the less volatile component condenses first allowing for concentration of the more volatile component in subsequent stages. The rectifier operates at correspondingly hotter temperatures than the stripper allowing energy transfer from the rectifier to the stripper.

### FIELD OF THE INVENTION

The present invention relates to a process for distillation of binary feed stocks and more particularly concentration of ethanol while significantly reducing the energy so utilized by transferring energy from a cooler stripper to a warmer rectifier.

### BACKGROUND OF THE INVENTION

Concerns related to decline of petroleum reserves along with related cost issues have caused increased interest in renewable energy sources. Implementation of renewable bio-fuels has significant promise. In addition to corn and sugar feed stocks, the hydrolysis of cellulose material to ethanol will allow for a wide diversity of biomass from urban, agricultural, and forestry sources as well as the cultivation of low energy consuming perennial crops such as switch grass. The aqueous alcohol solution obtained by fermentation or hydrolysis has a relatively low alcohol concentration, generally a range of four to over 10 percent by weight. For practical usage, the concentration must be increased in the distillation phase to 95-100% by weight. Historically, distillation of the feed-stock has been employed using a process invented well over a century ago. This process is not economical from an energy usage point of view because of difficulty recovering the evaporation latent heat. Distillation involves pressurized towers utilizing hot re-boilers for energy input and cool condensers for removing energy. A major disadvantage is the inability to reuse the cooler energy from the condenser in the re-boiler. In this common distillation method that is well over 100 years old, an energy level corresponding up to 5,000 thermal kJ/L or 18,000 Btu/gal is required for concentrating alcohol from 10% by weight to 95% by weight, for example. As taught in U.S. Pat. No. 5,800,681 (Berg), a more complex technology, extractive distillation, is a process to separate close-boiling compounds from each other by introducing a selectively-acting third component, the extractive distillation solvent, with the result that the relative volatility of the mixture to be separated is increased. A complication is the separation and then recovery of the often environmentally harmful third component. Another method to improve energy reuse in distillation columns involves vapor recompression. This technique increases the pressure and thus the temperature of the condenser vapor to above that found in the re-boiler, for example, as shown in U.S. Pat. No. 5,294,304 (Kano et al). In general, however, it has been found that vapor recompression systems tend to be capital-intensive and power consumptive.

### SUMMARY OF THE INVENTION

In view of the foregoing disadvantages inherent in the known methods to concentrate binary compositions, the present invention offers significantly improved utilization of energy when compared to conventional distillation. Furthermore, the apparatus is simple in its construction and can operate at atmospheric pressure.

The novel features of concentration by evaporation as disclosed in the present invention, which will be described subsequently in greater detail, can be best established and terms delineated by employing a more detailed discussion of conventional distillation. Distillation columns are found in many processes and, for instance, are employed in petroleum refineries and petrochemical complexes as well as in the concentration of ethanol. Their function is to separate volatile compounds by fractional distillation. The mixture enters in the lower portion of the column where heat is supplied to repeatable boiling of the feedstock and produce vapors which rise through the column (“the stripper”). The vapor condenses on platforms, known as trays, that are located inside the column and this liquid falls back into the trays below. The hottest tray is at the bottom and the coolest is at the top. At steady state conditions the vapor in each tray is at equilibrium. Only the most volatile of the vapors remains gaseous to the top of the column. The vapor at the top of the column then passes into a thermally separate condenser section (“the rectifier”) which reduces the vapor temperature until it liquefies. In binary separation of ethanol and water for instance, the least volatile compound is water such that it first condenses followed by the ethanol. As there is a blending of water and ethanol through part of the condensation process, a reflux capability is employed to achieve more complete separation of product. Reflux refers to the portion of condensed liquid product that is returned to the upper part of the column. Generally, the more reflux, the better is the column's separation of lower boiling materials from higher boiling materials. Energy reuse between the thermally separated stripper and rectifier is very limited. A liquid stream referred to as the bottoms liquid stream is withdrawn and has a temperature approximately equal to that found in the bottom of the column and therefore tends to be at a high relative temperature. Energy recovery from the bottoms stream is by its indirect heat exchange against a process stream which it is desired to heat although the major energy component of the distillation process resides in the latent heat of evaporation.

In comparison, the present invention teaches a reversal of temperatures relative to standard distillation and provides for evaporation of a feed stock such as ethanol and water at sub-boiling temperatures into a moving inert gas stream followed by preferential condensation of water and then ethanol from this inert gas stream. This reversal of temperatures allows re-use of energy in that it may be transferred from the warmer rectifier to the cooler stripper thus employing the energy released by condensation to provide most of the energy required for the evaporation. In another correspondence, conventional distillation columns provide internal trays to assist developing differences in temperatures and concentrations of liquids passing through the tower. This effect also is present in the process of this invention and is provided by the development of stages, each with unique properties of heat and concentration. Each stage contains a basin that is connected to a separate pump. The pumped basin liquid from a stripper stage is directed through a heat exchanger that exchanges heat with a correspondent liquid from a rectifier stage. After passage through the heat exchanger, liquids are distributed upon media such as that found in small cooling towers where the liquids are in contact with the gas flow before falling into the basin. A small stream of liquid is allowed to flow between stages and between the stripper and the rectifier.

This process utilizes gas which generally is noncombustible, as for example carbon dioxide that is a normal output from fermentation processes, or other moving gas to provide means allowing sensible and latent energy to be transferred. The gas is brought into a stripper stage that is cooler than its thermally connected rectifier stage. It increases in temperature while passing through subsequent stages and evaporates liquid. When at sufficient but sub-boiling temperature, the saturated gas exits the stripper stages and enters the first rectifier stage. The liquid is then increased in temperature by an auxiliary heater. As the vapor-laden gas in the condensation stage is now slightly elevated in temperature when compared to its thermally connected evaporation stage, the warmer gas in the condensation stage cools by heat transfer to the relevant evaporation stage by means of a liquid-to liquid heat exchanger, with this sequence repeated throughout multiple stages. As the gas cools, vapors condense giving up their heat of condensation to the correspondent evaporation stage. Each stage has separate pumps as well as a separate media upon which sensible and latent energies exchange occurs when contacted by the gas stream so that the liquid temperatures and composition profiles are maintained. The ethanol and water feedstock generally enters at or near the stage having the highest temperatures within the device.

As evaporation and condensation occurs, so do changes to the composition of the gas vapors. As the gas increases in temperature, the most volatile component of the liquid tends to evaporate from the liquid preferentially to the lesser volatile component. As the gas flows through the evaporation stages at ever increasing temperatures, it gains volatile vapors thereby depleting volatiles from the liquid phase. The liquid phase is allowed to flow slowly throughout multiple stages and can be nearly void of the ethanol, for example, when reaching the discharge port at the cool end of the device. Following a heat input the gas in the condensation stages begins to cool and becomes richer in the more volatile component as the lesser volatiles (water in case of an ethanol feed stock) condense preferentially thereby leaving the vapor phase richer in the more volatile component (ethanol). Concurrently, the gas phase experiences a richer volatile liquid phase that is moving countercurrent to it as an internal reflux. A richer volatile liquid phase of ethanol, for example, is produced from the condensing vapor and gas mixture as the gas moves to discharge liquids. As required, this liquid is channeled to a condenser containing one or more stages as previously described. Heat exchange is via standard heat exchangers exchanging heat from basin liquids to a cooled water source. The condenser further enriches the volatile component before its discharge from the device as distillate. In the event the gas contains significant volatile vapors a vapor remover may be employed to cleanse the gas before its return to the evaporation stages.

It is to be understood that the invention is not limited in its application to the details of construction for operation at atmospheric pressure as presented or at other pressures or vacuums, and to the arrangements of the components, set forth in the following description or illustrated in the drawings. The invention is capable of other embodiments, especially as related to the distillation of other binary or other liquids and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features, and advantages of the present invention will become fully appreciated as the same becomes better understood when considered in conjunction with the accompanying drawings, in which like reference characters designate the same or similar parts throughout the several views, and wherein:

FIG. 1 is a plan view with a portion of its cover removed of a device according to the present invention showing major components with certain of these shown schematically;

FIG. 2 is a cross-sectional view taken along lines 2-2 of FIG. 1 with portions shown schematically; and

FIG. 3 is an expanded plan view of a portion of the device of FIG. 1.

### DETAILED DESCRIPTION OF A PREFERRED EMBODIMENT

The present invention relates to distillation of binary fluids, especially the distillation of water and ethanol. As used herein, distillation means the separation of binary compounds such that each binary compound gains in purity. The present invention employs a gas stream of generally, for safety, a noncombustible gas such as carbon dioxide, nitrogen or helium. This gas repeatedly circulates through the device and operates under nearly constant pressure with pressure change caused by frictional losses. As used herein the gas is at nearly atmospheric pressure however other pressures or vacuums may be employed. The preferred process of the invention operates at under the boiling temperatures of the binary fluids although there may be applications wherein the process is improved by allowing one of the binary substances to reach a boiling temperature. The gas is employed as a sensible and latent heat transfer media affecting the stripping (evaporation) section and the rectifier (condensation) section. As is generally understood, sensible heat transfer is the movement of energy that cools or heats a fluid (liquid or gas) or evaporates a liquid or condenses a vapor that exchanges through a gas/liquid interface. Mass transfer is the movement of an evaporating liquid from the liquid phase into the gas phase or movement of a condensing vapor from a gas phase into the liquid phase. In the present invention, stripping is at a lower temperature than is the rectification. In order to effect this change, energy is added between these two activities. This energy change has two effects: First, it provides an energy differential between the gas in the stripper and rectifier. Second, it will be shown to assist development of a temperature range within the stripper and the rectifier. These changes cause the gas to continually approach a vapor-liquid equilibrium value which is receptive to receiving or losing vapors. An equilibrium value is a vapor-liquid equilibrium or temperature. A vapor liquid equilibrium can be said to exist when the escape tendency from liquid to a vapor phase is exactly balanced with the escape tendency from a vapor to a liquid phase at the same temperature and pressure.

Energy of condensing vapor within the rectifier is utilized to supply most of the energy needed to cause evaporation within the stripper thereby necessitating thermal connection between the rectifier and stripper. This connection first requires transfer between the liquid phase into the gas phase within the stripper and from the gas phase into the liquid phase within the rectifier. A preferred method of exchange is by means of a large wetted surface area in contact with the gas stream. This surface area may be supplied by media similar to that utilized in evaporative coolers or found in shape and materials common to cooling towers. The preferred method of wetting the media is by pumping liquid over the media employing suitable distribution means. The connection then requires a second step, that of connecting the thermal properties of the liquids within each the rectifier and the stripper. A preferred method for thermally connecting the rectifier and the stripper is by utilizing the same pumps to first transmit liquid through a liquid-to liquid heat exchanger with the liquid from the rectifier and from the stripper flowing counter-current to each other. Stages are then created as are found in standard distillation towers. In accordance with the present invention, these stages are developed along the length of the rectifier and the stripper portions of the device. These stages may be thought of as each having a media section, liquid collection basin, separate liquid movement devices, and separate heat exchangers. Further, this separation into stages provides that mixing of the gas and liquid phases is minimized between stages; that the liquid exiting a stage has different temperature and concentration than when it entered the stage and that the stages are sequentially ordered so that heat transfer from the rectifier and stripper stages generally occurs in a manner so as to continually change that of the segmented liquid in an orderly manner.

Evaporation within the stripper or condensation occurring within the rectifier causes the liquids in a stage to tend towards an equilibrium condition with the gas passing through the same stage. To avoid this occurrence a portion of the liquids is allowed to flow between stages. This inter-stage flow means that the actual movement of a liquid into and out of a stage that when exiting a stage has a concentration that is different from the liquid concentration when entering the stage. This inter-stage flow between stages allows the liquid concentration of one stage to influence the liquid concentration of an adjacent stage. The rate of this stage-flow between stages is governed by addition to or subtraction from the liquid supplied to one of the interconnected stages. Mitigation of stage equilibrium between the liquid concentrations as related to its adjacent gas stream also can occur by direct liquid transfer between the rectifier and the stripper. This activity is generally referred to as reflux flow within a standard distillation column.

In operation when concentrating ethanol from a binary feed stock of ethanol and water for illustration, inert gas is brought into the coldest stage of the stripper that is slightly cooler than the thermally opposite rectifier stage. The gas increases in temperature throughout each stage of the stripper and evaporates liquid from the wetted media thereby causing and maintaining a gas-saturated state. Energy needed for the gas temperature rise and for evaporation from the liquid to occur is furnished from the rectifier by means of the liquid-to-liquid heat exchangers. After sufficient temperature increase in the stripper but under the boiling point of ethanol, the saturated gas exits the stripper and returned to the first rectifier stages where the basin liquids and optionally the gas are heated. Given that the vapor-laden gas in the rectifier stage is slightly elevated in temperature above that of the stripper stage thermally opposite, the heated gas in the rectifier cools throughout the rectifier stages by heat transfer to the cooler stripper stages. As the gas cools, vapors condense within the media giving up the heat of condensation thereby warming the liquid wherein heat is transferred by the liquid-to-liquid heat exchangers to the correspondent stripper stage. As condensation and evaporation are occurring, so are changes to the composition of the gas stream and the liquids. As the gas increases in temperature in the stripper, ethanol (the most volatile component) will tend to evaporate from the feed stock in preference to water (the lesser volatile component). Utilization of stages acts to preserve the concentration and temperature of the liquid phase relative to the gas phase. As the gas moves through the stripper at ever increasing temperatures, it gains in ethanol vapors thereby depleting the ethanol from the liquid phase. The liquid phase, with stage-flow throughout the stripper can be nearly void of ethanol when it reaches the discharge port normally located at the cold end of the stripper. The gas, after completing its passage through the stripper and enters the rectifier where heat is added in the initial stages. Upon cooling, the gas becomes richer in ethanol (the more volatile component) as water (the lesser volatile component) condenses preferentially leaving the vapor richer in ethanol. In addition, the gas experiences a richer volatile liquid phase that is moving counter-current to it as internal reflux. This reflux occurs because condensate is formed at a higher rate than the distillate rate causing the excess liquid to move towards the heater and then flows back to the stripper as does the feed stock which enters the device in the stage that has the same ethanol/water composition as the feed stock. This internal reflux is at a maximum in the rectifier stage having the highest temperature and diminishes as the rectifier stages cool. At this point and throughout the remaining rectifier stages a richer ethanol phase is produced from the condensing vapor/gas mixture as the gas moves to exit the rectifier. Stage-flow of concentrated ethanol leaves the rectifier as distillate. In the event this liquid continues to contain significant ethanol, a condenser is employed for further purification. The condenser may be of multiple stages with the same structure as the stages within the rectifier. The pumped liquid, however, is first cooled by heat exchange with a colder liquid supplied from external sources thereby reducing its temperature. The liquid-to-liquid heat exchangers may be the same as utilized for heating the feedstock with the inclusion of narrowly spaced plate exchangers as no measurable solids are present. The distillate is then removed from the device. In most operations the gas will be circulated and its content of ethanol, for example, will affect the ethanol content of the bottoms liquid discharged from the stripper. A vapor remover may be employed having the same configuration as other stages and may be of multiple stages. Water is circulated through the media to absorb the ethanol before the gas passes through an air movement device such as a blower or fan on its pathway to again circulate through the stripper. The water, now with ethanol content, is generally returned to the stages of equivalent al ethanol-water mixture.

The apparatus for implementing the invention consists of a staged stripper and a staged rectifier that are generally placed in a horizontal position. These may be physically separated from each other as long as they are thermally connected. Each stage consists of wetting media, basin, pump and access to liquid flow through a liquid-to-liquid heat exchanger. Also utilized would be a heater providing an increase in temperature in the rectifier as well as separate mechanical means such as a blower or a fan to circulate the gas stream. In most cases a condenser is utilized. Additionally, scrubber may be employed to remove volatiles from the gas stream before its entrance into the stripper.

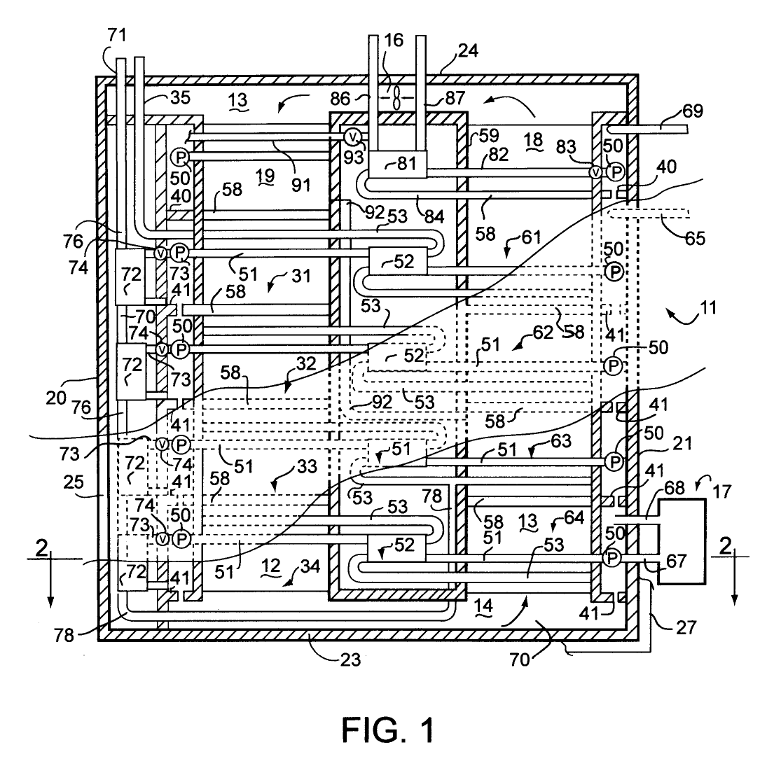

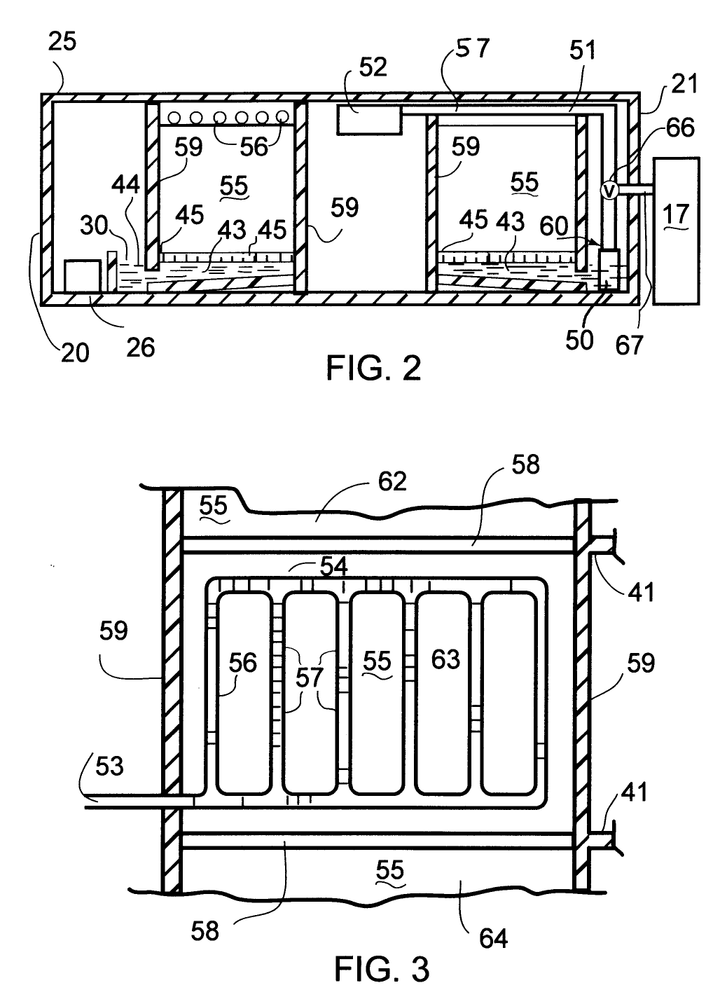

Referring descriptively to the drawings for mechanical function, in which similar reference characters denote similar elements throughout the several views, a device of the present invention is generally indicated in FIG. 1 and FIG. 2 by the numeral 11 along with stripper 12 and rectifier 13. The stripper and rectifier are connected by gas movement plenums 14 and 15 with plenum 15 generally containing gas movement unit 16 that may be a fan or blower, for instance. A heating element 17 is located in rectifier 13 near plenum 14. It provides heat to the liquids through indirect exchange and also may provide multiple functions including partially drying feedstock. Device 11 may also contain, if required, condenser 18 and scrubber 19. Device 11 is schematically shown as rectangular having side walls 20 and 21, end walls 23 and 24, top wall 25 (partially removed in FIG. 1) and bottom wall 26 and if desirable, with these walls thermally protected with insulation 27 that may be any efficient and highly vapor and liquid resistant material. Chamber length, height, and width dimensions are generally consistent throughout device 11 although stripper 12 and rectifier 13 may be of different dimensions and each may vary along their length with the provision that the change does not interfere with gas distribution within device 11. Materials may be of metal such as steel sheet or aluminum, or made in part from a rigid plastic. It is apparent from the above description that chambers stripper 12 and rectifier 13 may be positioned at some distance from each other. Further, air movement device 16 could be placed in another plenum of device 11.

Basins 30 and 60 are utilized for liquids present in stripper 12 and rectifier 13. These basins are each segmented into at least four stages, with four being shown in FIG. 1 as stages 31, 32, 33, and 34 of basin 30 and stages 61, 62, 63, and 64 of basin 60. The effective separation of binary liquids is generally increased by increasing the number of stages in stripper 12 and rectifier 13. To date, devices having up to 30 stripper stages and 30 rectifier stages have been constructed. Stripper 12 has exit pipe 35 located and the terminus of stage 31 where the exiting flow is nearly void of ethanol, for example. Rectifier 13 likewise is fitted with exit pipe 65 that is located in stage 61 and contains process distillate. Liquids associated with the stages are largely contained within stages; for instance within stage 31 by solid wall 40 or by wall 41 having an opening provision for staged-flow between stages as located between stages 31 and 32, 32 and 33, and 33 and 34 of basin 30. Likewise, liquids associated with stages of chamber 60 are contained within stage 61 by solid walls 40 (configurations without condensers) or walls 41 that allow for staged-flow between stages 61 and 62, 62 and 63, and 63 and 64. These basins are normally molded from a high temperature withstanding plastic or FRP to avoid seams but could be of a stronger material depending upon structural requirements. The profile of these basins generally includes surface area 43 to collect liquids, a sump 44, and may include submerged section 45 that provides for gas and liquid separation by means of the depth of sump liquid 46. A pump 50 is dedicated to each stage and may be located within sump 44 or may be placed external to sump 44. The pumped liquid first passes from pipe 51 to heat exchanger 52 with the flows of liquids from basins 30 and 60 most efficiently being in counter flow to each other. For instance, liquids from basin 31 would be heat exchanged with liquid from basin 61. The heat exchangers may be of standard configuration such as shell and tube, or plate and frame. Flow from heat exchanger 52 is directed by pipe 53 to liquid discharge assembly 54 that distributes basin liquid onto media 55 that is supported by open grid 45. An expanded view of one type of liquid discharge assembly 54 found adequate for distribution is presented in FIG. 3 and has been designed so that liquid flow is nearly evenly distributed over the media surface with any bias counter to the gas flow however the assembly may incorporate additional distribution tubes or other means to improve disposition of the liquid. The pipes, generally shown by numeral 56, may be of suitable plastic material with spaced openings 57 cut into the pipes 56 along their top surface in a “v” shaped pattern or these spaced openings could contain low pressure nozzles inserted into pipes 56. An expanded top view of one satisfactory distribution assembly 54 for a single stage is shown in FIG. 3.

Returning to FIGS. 1 and 2, means to prevent gas flowing past distribution pipes 56 from bypassing the media or is shown as blockage 57 which may be of a closed cell material such as thermal insulation shapes or molded plastic foam. Liquid thus distributed falls through media 55 by gravity into basins 30 and 60. Materials with augmented surface suitable for media 55 include that typically found in evaporator cooler products but modified to withstand higher temperatures, small saddles or rings found in smaller cooling towers, or other suitable material. An open space 58 between the media of each stage is generally employed in order to avoid liquid mixing between stages with a separation of at least one centimeter recommended. Open space 58 may contain blockage 57 between support plate 43 and grid 45 to further prevent gas bypassing media 55. Basin 70 connects basins 30 and 60 at stages 34 and 64 to allow staged liquid flow between basins 30 and 60, this liquid flow generally being in counter-current to the gas flow within plenum 14. Walls 41 may be employed between stage 34 and basin 70 and also between stage 64 and basin 70 in order to minimize mixing of liquids. Further containment of the gas flow is by placement of wall 59 that in conjunction with bottom wall 26, submerged wall 45, basins 30, 60 and 70 adjacent to and between media 55 in the event that wall 45 cannot be or is not employed, wall 59 may continue vertically or nearly so to attach to top wall 25. This wall configuration, along with those walls previously described as side walls 20 and 21, and end walls 23 and 24 provide for development of gas plenums 14 and 15 and gas containment when gas movement is through media 55 thereby allowing gas to be contained and circulated by air movement unit 17 within device 11. In this closed system, device 11 may be operated at pressures higher or lower than ambient provided device 11 was constructed to withstand pressure differentials. In the event that air is utilized as the gas, device 11 would generally operate at near atmospheric pressure and recycling of gas would not be necessary leading to elimination of plenum 15 connecting basins 30 and 60 and requiring relocation of air movement unit 16.

Liquid inlet 71 is located so that its liquid may be heated with liquid from basin 30 in a staged manner. Each stage has a separate heat exchanger 72 that receives basin liquid by means of pipe 73 that connects to pipe 51 with its liquid flow rate from pipe 51 controlled by valve 74 and is returned from heat exchanger 71 to basin 30 via pipe 75. Staged-flow of discharged liquid is removed from basins 30, generally passing from stage 34 to stage 31 at pipe 76 connected to heat exchanger 72. As depicted in a counter-current flow arrangement, feed stock liquid enters heat exchanger 72 via pipe 77 and exits the heat exchanger in pipe 78 which, in turn connects with the heat exchanger 72 located in the adjacent stage. For instance, feed liquid flows through the heat exchanger thermally connected to the basin of stage 31 followed by heat exchange of basin liquids in stage 32, stage 33, and then stage 34. Upon exiting heat exchanger 72 approximate to basin 70, the heated feed liquid is shown discharged into the basin of stage 63 by pipe 78 joining pipe 53 although the discharge position may be altered so that temperatures and concentrations of the feed liquid and the basin liquid correspond. Again, the liquid-to-liquid heat exchangers may be of any standard configuration such as shell and tube, plate and frame, or a continuous heat exchanger may be incorporated throughout the length of basin sump 44 as a finned metal coil or other suitable shape. Although not preferred, this liquid-to-liquid heat exchange of the feed stock with heated liquid may take place utilizing the liquids of basin 60 in a counter-flow manner.

A simple heat element 17 may be employed provided when the feedstock contains reduced solids as is often found when converting cellulose materials to ethanol owing to prior filtration before feedstock entry into pipe 71. Heat may be provided to the liquid of basin of stage 64 by any conventional indirect means using fossil energy receiving pumped liquid from pipe 51 now redirected by valve 66 and from pipe 51 through pipe 67 to the heater 17 with the heated liquid flowing from heater 17 by pipe 68 to enter heat exchanger 52. While not preferred, heat may be supplied by direct means such as steam injection into stage 64.

In the event condenser 18 is not needed to obtain the concentrate of distillate required, discharge pipe 65 from basin 60 is located within the basin of stage 61. In most operations further cooling than provided within rectifier 13 will be necessary to obtain a satisfactory product, for example ethanol at its azeotrope concentration. Condenser 18 relies on heat exchange with a cooler liquid and consists of multiple stages. Each condenser stage has a separate heat exchanger 81 that receives basin liquid by means of pipe 82 that connects to pipe 51 with its liquid flow rate from pipe 81 controlled by valve 83 and is returned from heat exchanger 81 to its stage via pipe 84. Staged-flow of chilled water enters heat exchanger 81 via pipe 86 and exits the heat exchanger in pipe 87 which, in turn connects with the heat exchanger 81 located in the adjacent stage. Liquids from basin 64 now exit to the warmest stage of the condenser by means of replacing wall 40 with wall 41 with wall 40 relocated to the terminus of the coldest stage with discharge pipe 65 now shown as pipe 69 connected to relocated wall 40. Heat exchangers may be as those described above but may include closely spaced plate exchangers as no measurable solids are present in the liquid. Chilled water may from ambient sources during many periods of the year, or be provided ground water throughout the year, or by water cooled by evaporative coolers during summer.

Gas circulated through device 11 should be nearly void of the volatile component before entering stripper 12. Purity can be enhanced by incorporation of stripper 19. Its preferred structure is very similar to the stages of rectifier 13. Water is brought into its basin 90 by means of pipe 91 and exits via pipe 92. The water flow entering basin 90 is controlled by valve 93 such that its ethanol composition, for example, may range from 50% to 80% and is higher when multiple stages are employed. Pipe 92 discharges its flow into the stage of device 11 having nearly the same composition as the contents of basin 90, shown here as stage 63. The stages of stripper 12 resemble those of rectifier 13 in geometry and material selection.

A small device has been constructed allowing preferential evaporation of ethanol from water and first condensing water and then ethanol, and transferring the heat of condensation to cause further evaporation. The device contained 30 stripper stages, 30 rectifier stages and 10 condenser stages. Heat was supplied between the stripper and rectifier by direct steam injection providing a steady-state temperature of 76 degrees C. (168 degrees F.), a temperature below the boiling point of ethanol. The feedstock consisted of a 10 percent ethanol water solution that entered the stripper at the rate of 29.5 kilograms per hour (65 pounds per hour). A noncombustible gas circulated through the device at the rate of 5.1 square meters per hour (3 cubic feet per minute).

Azeotrope ethanol distillate was achieved at the rate of 3.8 liters (one US gallon) per hour with a discharge (bottoms) liquid containing 0.1 percent ethanol. Gross thermal energy input to the device was 1.2 kW (4,100 Btu's per hour of which approximately 30% was calculated as thermal loss to the building owing to the area of the device relative to its rate of distillate. Movement of liquids required 88 kJ per liter (318 Btu's per hour per gallon) of azeotrope ethanol produced. Parasitic needs for gas movement were minimal owing to the insignificant pressure resistance throughout the device.

As to further discussion of the manner, usage, and operation of the present invention, the same should be apparent from the above description. Accordingly, no further discussion relating to the manner of usage and operation will be provided. With respect to the above description then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further since numerous modifications and changes will readily occur to those skilled in the art, it is not desired to limit the invention to the exact construction and operation shown and described.

Having fully described the invention in such clear and concise terms as to enable those skilled in the art to understand and practice the same, the invention claimed is:

1. Process for preferentially changing component concentrations of a binary fluid comprising:
first wetting means for stages of a first chamber wherein the temperature of the binary fluid is below its boiling temperature;
second wetting means for stages of the second chamber wherein the temperature of the binary fluid is below its boiling temperature;
heat exchange means thermally connecting stages of the first and second chamber
flow means coupled to the wetting means providing a flow of the binary fluid between stages;
flow control means for transferring a portion of the binary flow between the first and second chambers;
gas means for causing a gas to flow through the first and second chambers wherein the gas flow in each chamber is counter-current to the other;
thermal means located in the second chamber for providing heat to the binary fluid;
flow means for entering the binary fluid near the thermal means; and
the thermal means changing temperature of the gas flowing in the chambers causing a temperature difference between the chambers permitting heat transfer between the first and second wetting means and mass transfer between the first wetting means and the gas and between the second wetting means and the gas, wherein the gas approaches a vapor-liquid equilibrium with each wetting means in each stage, generally causing preferential evaporation from the binary fluid in the first chamber and preferential condensation in the second chamber resulting in stripping the more volatile component in the first chamber and concentration of the more volatile component in the second chamber.

2. Apparatus for distillation of binary fluids comprising:
a first chamber containing a plurality of stages;
wetting means for wetting substantially all of the stages of the first chamber with the binary fluid;
flow means coupled to the wetting means for providing flow of the binary fluid between adjacent stages;
a second chamber containing a second plurality of stages;
wetting means for wetting substantially all of the stages of the second chamber with the binary fluid;
flow means coupled to the second wetting means for providing flow of the binary fluid between adjacent stages;
gas means for controlling a flow of gas through the chambers, wherein the gas flow in the first chamber and second chamber is counter-current;
heat exchangers thermally connecting stages in the first chamber and stages in the second chamber;
flow control means for transferring a portion of the flow between the first and second chambers; and
temperature means for causing the temperatures of the first and second chambers to be different, this temperature difference resulting in transfer of heat between the chambers through the heat exchangers thermally connecting the stages, wherein temperatures of the binary fluid remains below its boiling temperature, wherein interaction in the stages between the binary fluid and the gas causes a change in the composition of the binary fluid with the gas approaching a vapor-liquid equilibrium with the binary fluid for each of the wetted stages, wherein interaction by the binary fluid and the inter-stage flow causes the concentration of the binary fluid of a stage to influence the concentration in an adjacent stage;

3. The apparatus of claim 2 wherein said gas is noncombustible.

4. The apparatus of claim 2 wherein said gas is continually circulated between said first chamber and said second chamber.

5. The apparatus of claim 2 further including a heat exchange means for providing heat exchange between the binary fluids prior to introduction of the binary substance.

6. The apparatus of claim 2 further comprising cooling means for cooling said gas prior to its flow into the first chamber.

7. The apparatus of claim 2 further including a stripper in the second chamber.

8. The process for distillation of binary fluids wherein:
stages of a first chamber are thermally connected to stages of a second chamber;
the first chamber operates at a higher temperature than the second chamber;
temperatures of fluids are less than their boiling temperatures;
gas operating pressures are near ambient;
the first chamber performs as a stripper; and
the second chamber performs as a rectifier.
